(19) United States
(12) Patent Application Publication
(10) Pub. No.: US 2010/0000371 A1
(43) Pub. Date: Jan. 7, 2010

(54) Adjustable Eccentric Drive

(75) Inventor: Juergen Roser, Haslach (DE)

Correspondence Address: Brinks Hofer Gilson & Lione/Ann Arbor, 524 South Main Street, Suite 200, Ann Arbor, MI, 48104, US

(73) Assignee: Supfina Grieshaber GmbH & Co. KG, Wolfach (DE)

(21) Appl. No.: 12/485,687

(22) Filed: Jun. 16, 2009

Related U.S. Application Data
(60) Provisional application No. 61/075,032, filed on Jun. 24, 2008.

(51) Int. Cl. F16C 3/28

(52) U.S. Cl. 74/571.11

(57) ABSTRACT

An adjustable eccentric drive is disclosed, including a first shaft and a crank pin connected to the first shaft, wherein a radial distance between the crank pin and an axis of rotation of the first shaft is adjustable with an adjusting collar; and a method for adjusting the stroke of an oscillating tool in a tool machine using the adjustable eccentric drive is disclosed.

### CROSS-REFERENCE TO RELATED APPLICATIONS

This application claims the benefit of provisional application Ser. No. 61/075,032, filed on Jun. 24, 2008, the contents of which are incorporated herein by reference in their entirety.

### FIELD

The present disclosure relates to a device for processing surfaces.

### BACKGROUND

In various cutting forms of processing, such as for example, super-finishing, honing, slotting and planing, the tool executes an oscillating motion. In this regard, a crank pin frequently is used which is arranged on a shaft at a distance A from the axis of rotation in order to convert the rotary motion of an electric drive into the desired oscillation motion.

Since the stroke of the oscillating motion is tool-dependent, among other things, it is desirable that the stroke of the crank pin is adjustable.

Previously there have only been possibilities for adjusting the stroke when the tools are standing still. This has the consequence that adjusting or changing the stroke of the oscillating motion is time and cost intensive.

Moreover, it is not possible to selectively influence and optimize the quality of the surface being processed by controlling the stroke of the processing tool.

### SUMMARY

The present disclosure provides an adjustable eccentric drive which makes possible the adjustment or alteration of the stroke of a crank pin when operating. Moreover, the stroke is to be adjusted continuously between a minimal stroke hₘᵢₙ and a maximal stroke hₘₐₓ.

Further provided is an adjustable eccentric drive with a first shaft and a crank pin, whereby the crank pin is connected with the first shaft and whereby a radial distance between the crank pin and an axis of rotation of the first shaft is adjustable with an adjusting collar arranged coaxially in relation to the first shaft, whereby the adjusting collar can rotate relative to the first shaft, whereby the adjusting collar has a spiral-shaped guide apparatus, and whereby the crank pin is form-locking with the guide apparatus.

By means of the coupling of the crank pin with the spiral-shaped guide apparatus and the rotation capability of the adjusting collar relative to the first shaft and thus also relative to the crank pin, it is possible to continuously adjust the eccentricity of the crank pin or the stroke of the crank pin.

This adjustment can take place when the first shaft is rotating. The adjustment range of the stroke depends upon the configuration of the spiral-shaped guide apparatus. Thus is it possible to construct the guide apparatus in the form of a circular segment, a logarithmic or Archimedean spiral arranged eccentrically to the axis of rotation of the first shaft. This enumeration is only by way of example and is not exclusive. In particular, it is also possible to adapt various stroke ranges to the present demand, corresponding to the pitch of the spirals. Hence, it can, for example, be advantageous with small strokes to select the pitch of the spirals, such that a very fine and exact adjustment of the stroke is possible. If a large stroke is necessary for rough-work processing, the pitch of the spiral-shaped guide apparatus can be selected greater and in this way a larger change of the stroke can be undertaken with a small angle of rotation between the adjusting collar and the first shaft. As a result of the guide apparatus changing the eccentricity of the crank pin and the stroke of the crank pin being equal to twice the eccentricity E, a very wide adjustment range of the stroke of the crank pin can consequently be realized.

By means of the coaxial arrangement of the first shaft and the adjusting collar, it is also possible to transfer greater forces in a radial direction between the guide apparatus and the crank pin, such that even heavy forms of processing with correspondingly great forces which act upon the tool and on the guide apparatus and the crank pin can be transferred safely and reliably over the entire lifetime.

The guide apparatus may be constructed as a spiral-shaped rib or groove and the crank pin includes rollers or pins which extend in a form-locking manner around the rib in a radial direction or dip into the groove.

If the guide apparatus is constructed as a spiral-shaped rib, the load-carrying capacity of the guide apparatus can be easily adapted to correspond to the requirements in that the cross section of the rib is correspondingly selected. It is also possible to manufacture almost all forms of spiral-shaped ribs precisely but nonetheless economically with the aid of an NC-controlled milling machine. Further, one roller or one pin can respectively be arranged on both sides of this rib, whereby the rollers or the ribs are connected with the crank pin. This means that the rib serves as a guide apparatus in both directions of the oscillating stroke motion.

The transmission of force from the rib takes place as a function of the stroke direction alternating across the roller resting externally on the rib and the roller resting internally on the rib.

If the rollers or the spacing of the rollers are configured so as to adjust in relation to one another, it is possible to apply the roller free of play to the rib. The abrasion of the rib or the roller can, if needed, be reset, so that a constant, high processing quality is guaranteed over the entire lifetime of the eccentric drive of the invention.

Further, it is provided that the adjusting collar is connected with a second shaft and that the second shaft is arranged coaxially in relation to the first shaft. The second shaft can be constructed as a hollow shaft and have a bearing for the first shaft on its internal diameter. A very compact and high capacity form of construction is possible in this way. It is also comparatively simple to implement the adjustment of the adjusting collar or the rotation of the adjusting collar by rotating the second shaft relative to the first shaft. This rotation of the two shafts arranged coaxially toward each other is also transferred directly to the adjusting collar due to the rigid connection between the adjusting collar and the second shaft.

In order to transfer the requisite torque from the first shaft to the crank pin, a linear guide basically positioned radially in relation to the axis of rotation of the first shaft is available for the crank pin. This linear guide can be constructed with a simple design as a linear guide on the front face of the first shaft. The crank pin correspondingly then has a guide element with a groove whose width corresponds to the surfaces of the linear guide of the first shaft running parallel to each other. First, a radial displacement of the crank pin relative to the axis of rotation of the first shaft is guaranteed by means of this linear guide. Second, a torque can be transferred between the first shaft and the crank pin by means of the linear guide and the corresponding groove in the guide block of the crank pin. This transfer is comparable to a jaw clutch and enables the transfer of even very great torques.

Alternatively, a typical commercial linear guide can be used which has only one degree of freedom in the radial direction and can not only transfer torques, but also forces acting in an axial direction of the first shaft and between the crank pin and the first shaft.

In order to keep the imbalance of the eccentric drive of the invention as low as possible regardless of the stroke of the crank pin selected, a balancing weight is provided on the first shaft in a further form, whose radial distance in relation to the axis of rotation of the first shaft is likewise adjustable. This balancing weight is arranged offset by 180 degrees in relation to the crank pin.

The adjustment of the radial spacing between the balancing weight and the axis of rotation of the first shaft likewise takes place with the aid of the adjusting collar of the invention. As a result, increased costs of the balancing weight are, first, comparatively low, and the eccentricity of the balancing weight can be adjusted in the same manner as the eccentricity of the crank pin. This means not only a simplification of construction, but also guarantees elimination of the imbalance of the crank pin by the balancing weight regardless of the adjusted stroke of the crank pin.

Further, it is provided that the first shaft and the adjusting collar are respectively driven by an electric drive and that the rate of revolution and/or phase angle of the first shaft and the adjusting collar are adjusted by the control unit of the electric drive. This means that the drive power for the crank pin is furnished by the electric drive of the first shaft, and the electric drive for the adjusting collar in the final analysis furnishes the positioning energy requisite for the adjustment of the stroke. If the stroke of the crank pin is to remain constant, the adjusting collar and the first shaft rotate with the same number of rotations. This can be guaranteed by a suitable actuation of the two electrical drives.

If the stroke is to be adjusted, a rotation of the adjusting collar relative to the first shaft can be undertaken by a corresponding acceleration or retardation of the adjusting collar.

A further alternative form provides that the first shaft and the adjusting collar are mechanically connected with each other and that resources for adjusting the phase angle of the first shaft and the adjusting collar are provided between the first shaft and the adjusting collar. Such resources for adjusting the phase angle can be realized as a hydraulic swiveling motor or as a purely mechanical solution, like they are known from camshaft adjusting systems of internal combustion motors.

Further advantages and features of the disclosure will be apparent, to those skilled in the art, from the following drawings, their description and the patent claims.

Further areas of applicability will be apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1: A partial longitudinal section and a view from the front of a first shaft and an adjusting collar,

FIG. 2: A first shaft and an adjusting collar as well as a crank pin and a balancing weight in exploded representation,

FIGS. 3.1, 3.2 and 3.3: A view from the front of the first shaft and the adjusting collar in three different phase angles and

FIG. 4 to 6: Additional forms of adjusting devices of the disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

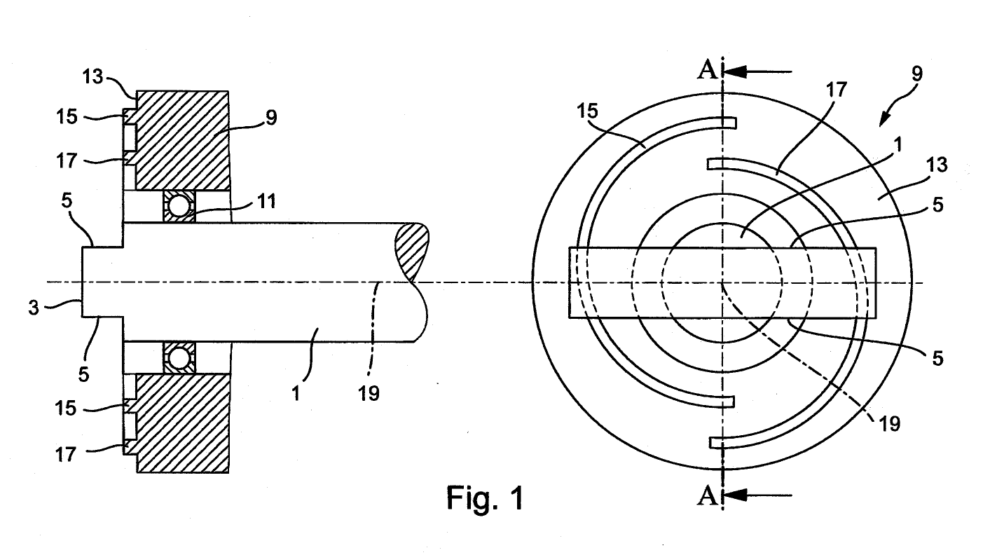

A first shaft 1 is represented in FIG. 1. The first shaft 1 is mounted so as to rotate in a non-depicted housing. A linear guide 5 is constructed on a front face 3 of the first shaft. A bearing 11 is arranged between an adjusting collar 9 and the first shaft 1. This means that the adjusting collar 9 is able to rotate in relation to the first shaft 1. A front surface 13 of the adjusting collar 9 has a first guide rib 15 and a second guide rib 17. The guide ribs 15 and 17 are spiral-shaped within the meaning of the invention, since the distance of the guide ribs from an axis of rotation 19 of the first shaft 1 is angle-dependent. With the form represented in FIG. 1, the spiral-shaped ribs 15 and 17 are executed as circular segments which are arranged eccentrically in relation to the axis of rotation 19. It is, nonetheless, also possible to construct the spiral-shaped ribs 15 and 17 as Archimedean or logarithmic spirals. It is also possible to configure the pitch of the spirals as angle-dependent.

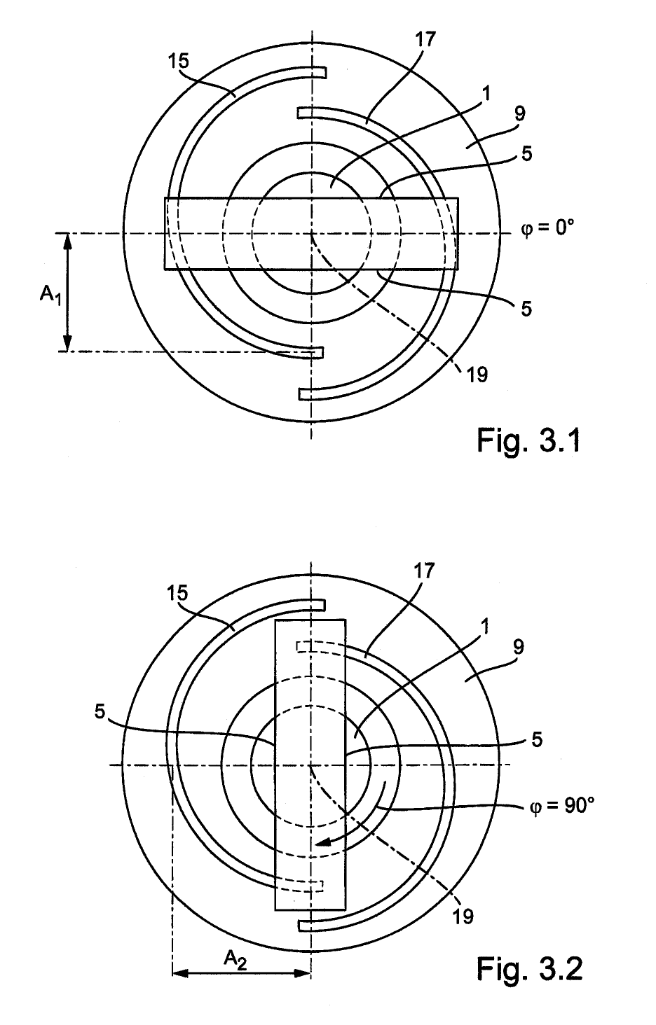

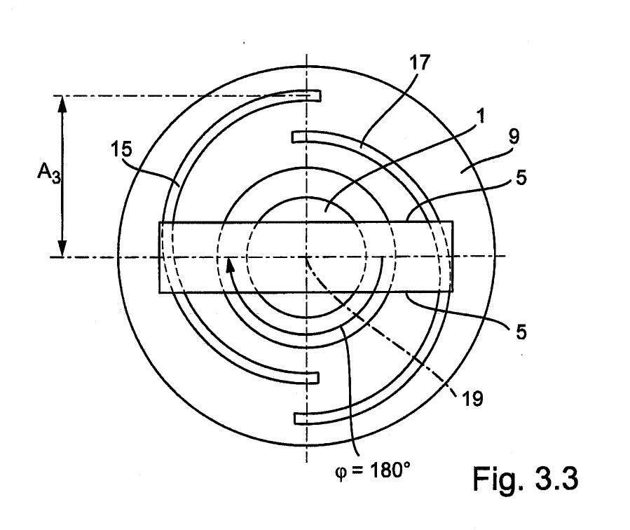

If the adjusting collar 9 is rotated relative to the linear guide 5 of the first shaft, then the spacing of the part of the guide ribs 15 and 17 which is situated in the extension of the linear guide 5 also changes. This association will be explained in greater detail below on the basis of FIGS. 3.1-3.3.

The linear guide 5 basically has two tasks. The first task consists in transferring torque from the first shaft 1 to a crank pin (not depicted). The second task of the linear guide 5 consists in making possible a radial displacement of the non-depicted crank pin relative to the axis of rotation 19.

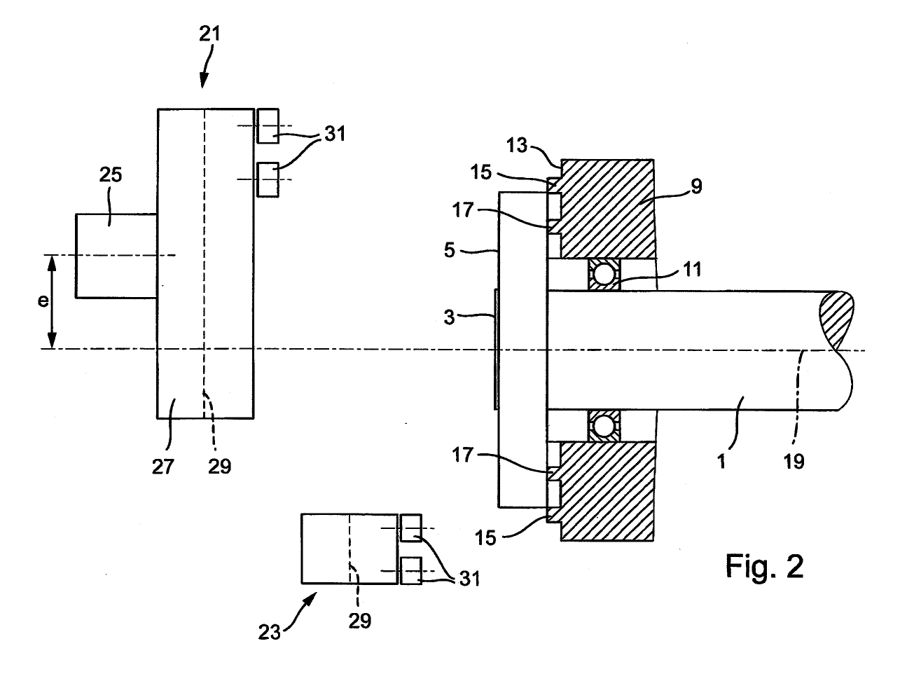

The adjusting collar 9 and the first shaft 1 as well as a crank pin 21 and a balancing weight 23 are represented in an exploded view in FIG. 2. Furthermore, the first shaft 1 and with it the linear guide 5 are represented as rotated by 90 degrees compared with the representation in accordance with FIG. 1.

The crank pin 21 includes a cylindrical pin 25 and a guide element 27. The cylindrical pin 25 is offset by an eccentricity e in relation to the axis of rotation 19 of the first shaft. In order to guarantee the displacement in a radial direction of the crank pin 21 relative to the axis of rotation 19 of the first shaft, a prismatic groove 29 with a rectangular cross section is carved out in the guide element 27. In a first and very simple embodiment, the linear guide 5 is constructed as solid material with a rectangular cross section which is guided to slide in the groove 29. A preferred variant provides that the linear guide 5 is constructed as a typical commercial linear guide, especially with drum elements (not depicted), and which is connected, on the one hand, with the first shaft 1 and, on the other, with the guide element 27. The relative motion between the first shaft 1 and the guide element 27 thus takes place within the linear guide 5 and with the aid of drum elements. Such linear guides can orthogonally transfer forces between the first shaft 1 and the guide element 27 in relation to the long axis of the linear guide.

In other words, the crank pin 21 can be put on the linear guide 5 with the groove 27 and be slid in a radial direction relative to the axis of rotation 19 of the first shaft 1. At the same time, a torque can be transferred from the first shaft 1 to the crank pin 21 by means of the linear guide 5, as already mentioned.

Two rollers 31 are fastened on the side of the guide element 27 facing the adjusting collar 9. The clear width between the two rollers 31 corresponds to the thickness of the first rib 15. This means nothing other than that the crank pin 21 is fixed in a radial direction by the first guide rib 15 as soon as it is put upon the linear guide 5 with the groove 29. Obviously, care should be taken here that the rollers 31 lie on the first guide rib 15 as free of play as possible.

If the adjusting collar 9 is now rotated relative to the first shaft 1, the eccentricity e of the cylindrical pin 25 also changes, since the first guide rib 15 is arranged in the form of a spiral.

The same applies for the balancing weight 23. The balancing weight likewise has a groove 29 and two rollers 31 which interact in a form-locking manner with the second guide rib 17 as soon as the balancing weight 23 is placed upon the linear guide 5. These rollers 31 interact with the second guide rib 17 in the same manner as the rollers 31 of the crank pin 21 interact with the first rib 15. In this way, a radial displacement capability of the balancing weight 23 relative to the axis of rotation 19 is also present.

If now the adjusting collar 9 is rotated relative to the first shaft 1, the crank pin 21 and the balancing weight 23 shift radially outward or inward corresponding to the relative motion of the adjusting collar 9. This kinematics will be explained below in somewhat greater detail on the basis of FIG. 3. FIG. 3.1 corresponds to the plan view in accordance with FIG. 1. In this plan view, the long axis of the linear guide 5 runs horizontally corresponding to an angle of rotation φ=0 degrees. In an orthogonal direction toward the long axis of the linear guide 5, the spacing between the axis of rotation 9 and the beginning of the first guide rib 15 is the amount A₁ in FIG. 1.

In FIG. 3.2, the first shaft 19 is represented as rotated by 90 degrees relative to the adjusting collar 9. The angle of rotation φ consequently is 90 degrees. In this representation, the long axis of the leaner guide 5 runs in a vertical direction. Correspondingly, the distance of the part of the first guide rib 15 positioned orthogonally in relation to the long axis of the linear guide 5 equals A₂. The spacing A₂ is greater than the spacing A₁ in FIG. 3.1.

If one now further rotates the first shaft 1 relative to the adjusting collar 9, so that an angle of rotation φ of 180 degrees occurs, as represented in FIG. 3.3, then there arises a spacing A₃ between the axis of rotation 19 of the first shaft 1 and the first guide rib 15 in the orthogonal direction toward the long axis of the linear guide 5. A₃>A₂>A₁ applies. In other words, due to the relative rotation according to the invention between the adjusting collar 9 and the first shaft 1, it is possible to alter the distance between the axis of rotation 19 of the first shaft 1 and the first guide rib 15 continuously. The spacing A₁ (φ=0 degrees) is constructively established as a minimal value. The maximal value is attained at a rotation angle φ=180 degrees and has the designation A₃ in FIG. 3.3. It is obvious that the values A₁ and A₃ can be established by a corresponding configuration of the first guide rib 15 corresponding to the requirements of the application.

It is also possible to execute the guide ribs as Archimedean or logarithmic spirals or with a free form instead of circular segment guide ribs 15 and 17 which are constructed in accordance with the requirements of the application.

The kinematics concerning the balancing weight 23 correspond to the kinematics of the crank pin 21. The only difference consists of the balancing weight 23 engaging with its rollers 31 into the second guide rib 17. This second guide rib has the same shape as the first guide rib 15 and is arranged offset by 180 degrees. In this way, it is guaranteed that the balancing weight constantly experiences a displacement in the radial direction whose amount is just as large as the displacement of the crank pin 21, but is oriented in the opposite direction. In this way, a balance of mass between the crank pin 21 and the balancing weight 23 can be attained regardless of the eccentricity e of the cylindrical pin 25.

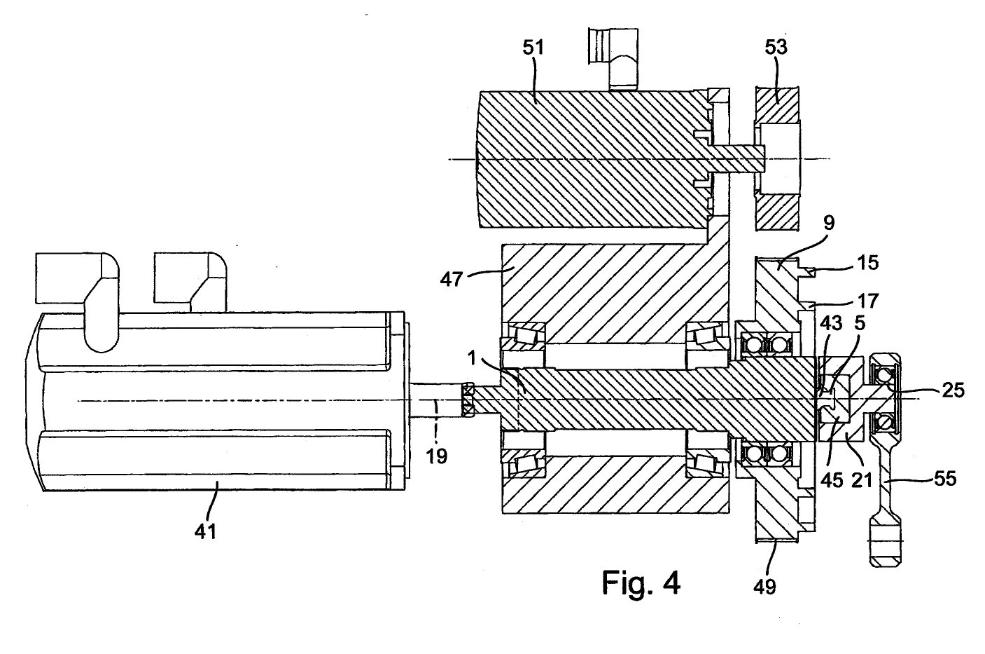

A form of the adjustable eccentric drive of the invention is shown in a cutaway view in FIG. 4. The same components are provided with the same reference numbers and what was said in the other figures applies correspondingly.

The first shaft 1 is driven by a first electric drive 41. The linear guide 5 is, as is apparent from the cutaway representation according to FIG. 4, a typical commercial standard element with a guide rail 43 and a carriage 45. The guide rail 43 is rigidly connected with the front face of the first shaft, while the guide carriage 45 is inserted into a groove 47 of the crank pin 21.

The first shaft 1 is axially and radially mounted in a housing 47 by means of a tapered roller bearing. The adjusting collar 9 is mounted on the first shaft 1 with two deep groove ball bearings. The adjusting collar 9 has a gearing 49 for a toothed belt (not shown) on its outside diameter. The adjusting collar 9 is driven by a second electric drive 51. This second electric drive has a belt pulley 53 which is arranged flush with the adjusting collar 9. A not represented toothed belt is laid over the belt pulley 53 and the adjusting collar 9, so that a slip-free transfer of rotary motion of the second electric drive 51 with respect to the adjusting collar 9 is guaranteed. It is possible to precisely control the rotational speed of the first shaft 1 and the adjusting collar 9 through a corresponding actuation of the first drive 41 and the second drive 51. Consequently, it is possible that the first shaft 1 and the adjusting collar 9 rotate with exactly the identical rate of revolution, so that no relative movement or rotary motion of the adjusting collar 9 takes place relative to the first shaft 1. In this state, the stroke of the cylindrical pin 25 remains constant. If now because of a corresponding actuation, for example of the second electric drive, the rotational speed of the adjusting collar 9 becomes somewhat elevated for a short time or is diminished, the adjusting collar 9 rotates relative to the first shaft. As a consequence of this, as was explained thoroughly on the basis of FIG. 3, the stroke of the cylindrical pin 25 is altered in the manner of the invention.

A connecting rod 55, which is mounted so as to swivel on the cylindrical pin 25, serves to convert the circular motion of the pin 25 into an oscillating linear motion.

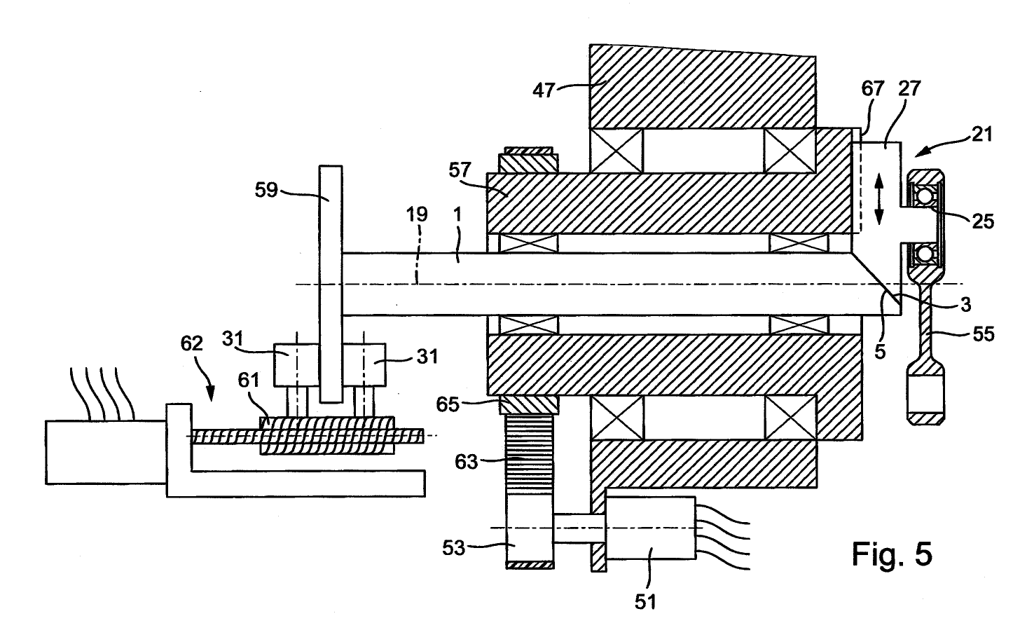

A further adjustable eccentric drive of the invention is represented in FIG. 5. Identical components have the same reference number and what was said regarding the other forms correspondingly applies.

In this form, a second shaft 57 is arranged coaxially in relation to the first shaft 1 which is constructed as a hollow shaft. The second shaft 57 is mounted in the housing 47. The first shaft 1 is likewise mounted in a radial direction in a pass-through hole of the second shaft 57. The first shaft 1 is moveable relative to the second shaft 57 in an axial direction.

In this form, the crank pin 21 is driven by the second shaft 57, while the adjustment of the stroke takes place from a linear drive with the aid of the first shaft 1.

A disk 59 is present at the left end of the first shaft 1 in FIG. 5 which is fixed in place in an axial direction between two rollers 31. The rollers 31 are mounted on a carriage 61. This carriage 61 can be moved in an axial direction by means of a linear drive 62 which is shown here as a threaded spindle with an electric drive. The positioning motion of the linear drive 62 is indicated by a double arrow. Of course, other forms of construction of linear drives can be relied upon for adjusting the carriage 61 or the first shaft 1.

The second shaft 57 is driven by the second electric drive 51 and a toothed belt 63. For this purpose, a belt pulley 65 is attached to the second shaft 57. The second shaft 57 has on its right end in FIG. 5 a plane surface 67. A radially running groove 69 is worked in on this plane surface 67. The crank pin 21 or its base body 27 is radially guided in this groove 69.

Furthermore, the front face 3 of the first shaft 1 is constructed in the form of a truncated cone and has a linear guide 5 which couples the crank pin 21 or the base body 27 of the crank pin in a form-locking manner to the first shaft 1. In this way, an axial motion of the first shaft 1 is converted into a radial movement of the crank pin 21 with the aid of a linear drive 62.

By guiding the crank pin 21 in the radially arranged groove 67 of the second shaft 57, even great torques can be transferred to the crank pin 21. Due to the form-locking connection of the first shaft 1 and the crank pin 21, it is also guaranteed with the aid of the linear guide 5 that the crank pin 21 is not carried outward due to the centrifugal forces acting upon it. The centrifugal forces acting on the crank pin 21 are also transferred from the linear guide 5 to the first shaft 1 and its mounting (without reference number) in the second shaft 57. In the same way, the non-depicted balancing weight 23 can be adjusted in a radial direction.

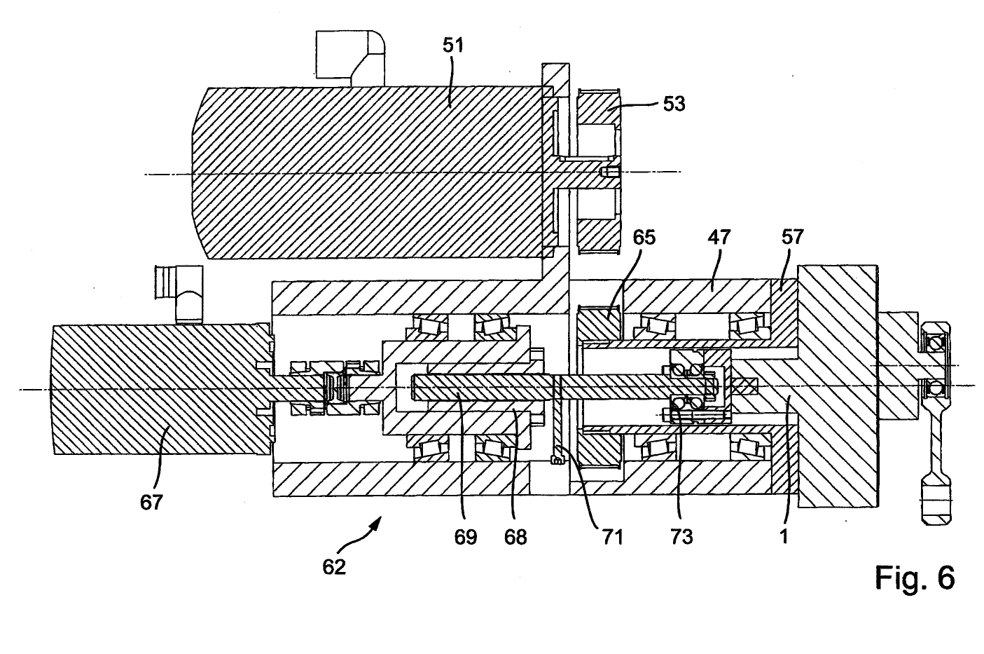

A linear drive 62 is represented in FIG. 6. The first shaft 1 is relatively short in this embodiment. The mounting of the first shaft 1 is not represented.

The mechanism with which the stroke of the crank pin 21 can be adjusted corresponds to what is represented in FIG. 5, and is therefore not illustrated once again in detail in FIG. 6. With the actuator 62 shown in FIG. 6, an electric motor 67 operates on a nut 68 which interacts with a threaded rod 69. The threaded rod 69 is positioned in a torque-proof but axially displaceable manner in the housing 47 by means of a screw 71. An axial motion of the threaded rod 69 is transferred to the first shaft 1 through a bearing 73.

In this form, the electric drive may only be activated when the stroke of the crank pin 21 is to be adjusted. The first shaft 1 is driven indirectly by the second shaft 57. The torque transfer can take place here by means of a non-depicted gearing or exclusively by the crank pin 21 and the linear guide 5 (see FIG. 5).

It should be noted that the disclosure is not limited to the forms described and illustrated as examples. A large variety of modifications have been described and more are part of the knowledge of the person skilled in the art. These and further modifications as well as any replacement by technical equivalents may be added to the description and figures, without leaving the scope of the protection of the disclosure.

What is claimed is:

1. An adjustable eccentric drive comprising a first shaft and a crank pin connected to the first shaft, wherein a radial distance between the crank pin and an axis of rotation of the first shaft is adjustable with an adjusting collar arranged coaxially toward the first shaft, whereby the adjusting collar can rotate in relation to the first shaft, the adjusting collar having a guide apparatus, and wherein the crank pin is coupled with the guide apparatus.

2. The eccentric drive of claim 1 wherein the crank pin is form-locked with the guide apparatus.

3. The eccentric drive of claim 1, wherein the guide apparatus is a spiral-shaped rib or a groove, and wherein the crank pin includes one or more rollers or pins which embrace the rib or engage into the groove of the guide apparatus.

4. The eccentric drive of claim 1 wherein the adjusting collar is connected with a second shaft that is arranged coaxially in relation to the first shaft.

5. The eccentric drive of claim 1 wherein the first shaft includes a linear guide positioned substantially radially toward the axis of rotation of the first shaft, for connecting with the crank pin.

6. The eccentric drive of claim 1 wherein the first shaft includes a balancing weight, wherein a radial spacing (A) between the balancing weight and the axis of rotation of the first shaft is adjustable, and wherein the balancing weight is positioned offset by 180 degrees in relation to the crank pin.

7. The eccentric drive of claim 1 wherein the first shaft and the adjusting collar are respectively driven by an electric drive having a control unit, and wherein a rate of revolution or a phase angle between the first shaft and the adjusting collar are adjusted by the control unit of the electric drive.

8. The eccentric drive of claim 1 wherein the first shaft and the adjusting collar are coupled mechanically with each other, and wherein means for adjusting the phase angle between the first shaft and the adjusting collar is provided between the first shaft and the adjusting collar.

9. A method for adjusting the stroke of an oscillating tool in a tool machine comprising using the adjustable eccentric drive of claim 1.

10. The eccentric drive of claim 3 wherein the one or more rollers or pins embrace the rib, form-locking in a radial direction.

11. The eccentric drive of claim 5 wherein the linear guide is located on a front face of the first shaft, and wherein the crank pin includes a guide element having a guide groove for interacting with the linear guide.

12. The eccentric drive of claim 11, wherein the front face of the first shaft is a conic stump-shaped front face, and wherein the linear guide is positioned on the front face for interacting with the guide element of the crank pin.

13. The eccentric drive of claim 6, wherein the radial spacing (A) between the balancing weight and the axis of rotation of the first shaft is adjustable with the aid of the adjusting collar.

14. The eccentric drive of claim 8, wherein means for adjusting the phase angle comprises a hydraulic swivel motor or a camshaft adjusting system of an internal combustion motor.

15. The method of claim 9 wherein the tool is a finishing machine.

16. The method of claim 9 further comprising adjusting a radial distance between the crank pin and the axis of rotation of the first shaft of the eccentric drive.

17. The eccentric drive of claim 14, wherein the camshaft adjusting system includes one or more of: automatic locking, oblique gearing or an adjustable chain or belt drive.
